(19) United States
(12) Patent Application Publication
(10) Pub. No.: US 2006/0165301 A1
(43) Pub. Date: Jul. 27, 2006

(54) Video coding method and apparatus for efficiently predicting unsynchronized frame

(75) Inventors: Sang-Chang Cha, Hwaseong-si (KR); Woo-Jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/336,825

(22) Filed: Jan. 23, 2006

Related U.S. Application Data
(60) Provisional application No. 60/645,010, filed on Jan. 21, 2005.

(30) Foreign Application Priority Data
Mar. 12, 2005 (KR) 10-2005-0020812

(51) Int. Cl. G06K 9/46

(52) U.S. Cl. 382/240

(57) ABSTRACT

A method of efficiently predicting a frame having no corresponding lower layer frame in video frames having a multi-layered structure, and a video coding apparatus using the prediction method is provided. In the video encoding method, motion estimation is performed by using a first frame of two frames of a lower layer temporally closest to an unsynchronized frame of a current layer as a reference frame. A residual frame between the reference frame and a second frame of the lower layer frames is obtained. A virtual base layer frame at the same temporal location as that of the unsynchronized frame is generated using a motion vector obtained as a result of the motion estimation, the reference frame, and the residual frame. The generated virtual base layer frame is subtracted from the unsynchronized frame to generate a difference, and the difference is encoded.

### CROSS-REFERENCE TO RELATED APPLICATIONS

This application claims priority from Korean Patent Application No. 10-2005-0020812 filed on Mar. 12, 2005 in the Korean Intellectual Property Office, and U.S. Provisional Patent Application No. 60/645,010 filed on Jan. 21, 2005 in the United States Patent and Trademark Office, the disclosures of which are incorporated herein by reference in their entirety.

### BACKGROUND OF THE INVENTION

1. Field of the Invention

The present invention relates, in general, to a video compression method and, more particularly, to a method of efficiently predicting a frame having no corresponding lower layer frame in video frames having a multi-layered structure, and a video coding apparatus using the prediction method.

2. Description of the Related Art

With the development of information and communication technology using the Internet, video communication has increased along with text and voice communication. Conventional text-based communication methods are insufficient to satisfy consumers' various desires, therefore multimedia services capable of accommodating various types of information, such as text, images and music, have increased. Multimedia data is large, and thus, it requires high capacity storage media, and a wide bandwidth for transmission. Therefore, in order to transmit multimedia data including text, images and audio, it is essential to use compression and coding techniques.

The basic principle of compressing data involves a process of removing redundancy. Spatial redundancy, in which the same color or object is repeated in an image, temporal redundancy, in which an adjacent frame varies little in moving image frames or in which the same sound is repeated in audio data, and psycho-visual redundancy, which takes into consideration the fact that human vision and perceptivity are insensitive to high frequencies, are removed so that data can be compressed. In a typical video coding method, temporal redundancy is removed using temporal filtering based on motion compensation, and spatial redundancy is removed using a spatial transform.

In order to transmit generated multimedia data after the redundancy has been removed, transmission media are required. The performances of the transmission media differ. Currently used transmission media have various data rates ranging from a data rate like that of an ultra high speed communication network, capable of transmitting data at a data rate of several tens of Mbit/s, to a data rate like that of a mobile communication network, having a data rate of 384 Kbit/s. In this environment, a method of transmitting multimedia data at a data rate suitable for supporting transmission media having various data rates or depending on various transmission environments, that is, a scalable video coding method, may be more suitable for a multimedia environment.

Such scalable video coding denotes an encoding method of cutting part of a previously compressed bit stream depending on surrounding conditions, such as a bit rate, an error rate or system resources, thus controlling the resolution, the frame rate and the bit rate of the video. With respect to such scalable video coding, Moving Picture Experts Group-21 (MPEG-4) part 10 has already achieved the standardization thereof. In the standardization of scalable video coding, many efforts have been made to realize multi-layered scalability. For example, multiple layers, including a base layer, a first enhancement layer, and a second enhancement layer, are provided, so that respective layers can be constructed to have different frame rates or different resolutions, such as the Quarter Common Intermediate Format (QCWI), CIF and 2CIF.

FIG. 1 is a diagram showing an example of a scalable video codec using a multi-layered structure. First, a first layer is defined as a Quarter Common Intermediate Format (QCIF) having a frame rate of 15 Hz, a first enhancement layer is defined as a Common\Intermediate Format (CIF) having a frame rate of 30 Hz, and a second enhancement layer is defined as a Standard Definition (SD) having a frame rate of 60 Hz. If a CIF 0.5 Mbps stream is required, a bit stream needs to be cut and transmitted so that the bit rate is 0.5 Mbps in the first enhancement layer with CIF_{—}30Hz_{—}0.7M. Using this method, spatial, temporal and SNR scalabilities can be realized.

As shown in FIG. 1, frames in respective layers having the same temporal location (for example, 10, 20, and 30) can be assumed to have similar images. Therefore, a method of predicting the texture of a current layer from the texture of a lower layer (directly, or after the texture of the lower layer has been upsampled), and encoding the difference between the predicted value and the actual texture of the current layer, is generally known. “Scalable Video Model 3.0 of ISO/IEC 21000-13 Scalable Video Coding” (hereinafter referred to as “SVM 3.0”) calls the above method as “Intra-BL prediction”.

In this way, SVM 3.0 additionally adopts a method of predicting a current block using a correlation between a current block and a corresponding lower layer block, in addition to inter-prediction and directional intra-prediction, which are used to predict blocks or macroblocks constituting a current frame, in the existing H.264 method. Such a prediction method is designated “Intra-BL prediction”, and a mode of performing encoding using Intra-BL prediction is designated an “intra BL mode”.

FIG. 2 is a schematic diagram showing the three prediction methods; case 1 when intra prediction is performed with respect to a certain macroblock 14 of a current frame 11; case 2 when inter prediction is performed using a frame 12 placed at a temporal location differing from that of the current frame 11; and case 3 when Intra-BL prediction is performed using the texture data of an area 16 of a base layer frame 13 corresponding to the macroblock 14.

As described above, in the scalable video coding standards, an advantageous method is selected among the three prediction methods.

However, if frame rates between layers are different, as shown in FIG. 1, a frame 40 having no corresponding lower layer frame may exist. With respect to the frame 40, Intra-BL prediction cannot be used. Accordingly, in this case, the frame 40 is encoded using only information about a corresponding layer (that is, using inter-prediction and intra-prediction) without using information about a lower layer, so that the prediction methods may be somewhat inefficient from the standpoint of encoding performance.

### SUMMARY OF THE INVENTION

Accordingly, the present invention has been made keeping in mind the above problems occurring in the prior art, and an aspect of the present invention provides a video coding method, which can perform Intra-BL prediction with respect to an unsynchronized frame.

Another aspect of the present invention provides a scheme which can improve the performance of a multi-layered video codec using the video coding method.

In accordance with one aspect of the present invention, there is provided a multi-layered video encoding method, comprising (a) performing motion estimation by using a first frame of two frames of a lower layer temporally closest to an unsynchronized frame of a current layer as a reference frame; (b) obtaining a residual frame between the reference frame and a second frame of the lower layer frames; (c) generating a virtual base layer frame at the same temporal location as that of the unsynchronized frame using a motion vector obtained as a result of the motion estimation, the reference frame, and the residual frame; (d) subtracting the generated virtual base layer frame from the unsynchronized frame to generate a difference; and (e) encoding the difference.

In accordance with another aspect of the present invention, there is provided a multi-layered video decoding method, comprising (a) reconstructing a reference frame from a lower layer bit stream about two frames of a lower layer temporally closest to an unsynchronized frame of a current layer; (b) reconstructing a first residual frame between the two lower layer frames from the lower layer bit stream; (c) generating a virtual base layer frame at the same temporal location as the unsynchronized frame using a motion vector included in the lower layer bit stream, the reconstructed reference frame and the first residual frame; (d) extracting texture data of the unsynchronized frame from a current layer bit stream, and reconstructing a second residual frame for the unsynchronized frame from the texture data; and (e) adding the second residual frame to the virtual base layer frame.

In accordance with a further aspect of the present invention, there is provided a multi-layered video encoder, comprising means for performing motion estimation by using a first frame of two frames of a lower layer temporally closest to an unsynchronized frame of a current layer as a reference frame; means for obtaining a residual frame between the reference frame and a second frame of the lower layer frames; means for generating a virtual base layer frame at the same temporal location as that of the unsynchronized frame using a motion vector obtained as a result of the motion estimation, the reference frame, and the residual frame; means for subtracting the generated virtual base layer frame from the unsynchronized frame to generate a difference; and means for encoding the difference.

In accordance with yet another aspect of the present invention, there is provided a multi-layered video decoder, comprising means for reconstructing a reference frame from a lower layer bit stream about two frames of a lower layer temporally closest to an unsynchronized frame of a current layer; means for reconstructing a first residual frame between the two lower layer frames from the lower layer bit stream; means for generating a virtual base layer frame at the same temporal location as the unsynchronized frame using a motion vector included in the lower layer bit stream, the reconstructed reference frame and the first residual frame; means for extracting texture data of the unsynchronized frame from a current layer bit stream, and reconstructing a second residual frame for the unsynchronized frame from the texture data; and means for adding the second residual frame to the virtual base layer frame.

### BRIEF DESCRIPTION OF THE DRAWINGS

FIG. 1 is a diagram showing an example of a scalable video codec using a multi-layered structure;

FIG. 2 is a schematic diagram showing three conventional prediction methods;

FIG. 3 is a schematic diagram showing the basic concept of Virtual Base-layer Prediction (VBP) according to aspects of the present invention;

FIG. 4 is a diagram showing an example of the implementation of VBP using the forward inter-prediction of a base layer;

FIG. 5 is a diagram showing an example of the implementation of VBP using the backward inter-prediction of a base layer;

FIG. 6 is a diagram showing the basic concept of a process of considering variation in motion and generating a temporary frame according to aspects of the present invention;

FIGS. 7A to 7E are diagrams showing a process of generating a temporary frame according to a first exemplary embodiment of the present invention;

FIGS. 8A and 8B are diagrams showing a process of generating a virtual base layer frame from the temporary frame according to a second exemplary embodiment of the present invention;

FIG. 9 is a diagram showing variation in texture between the corresponding areas of frames;

FIG. 10 is a diagram showing a concept of the application of texture variation to a temporary frame according to a first exemplary embodiment of the present invention;

FIG. 11 is a diagram showing a concept of the application of texture variation to a temporary frame according to a second exemplary embodiment of the present invention;

FIG. 12 is a block diagram showing the construction of a video encoder according to an exemplary embodiment of the present invention;

FIG. 13 is a block diagram showing the construction of a video decoder according to an exemplary embodiment of the present invention;

FIG. 14 is a diagram showing the construction of a system environment in which the video encoder of FIG. 12 and the video decoder of FIG. 13 operate;

FIG. 15 is a flowchart showing a video encoding process according to an exemplary embodiment of the present invention; and

FIG. 16 is a flowchart showing a video decoding process according to an exemplary embodiment of the present invention.

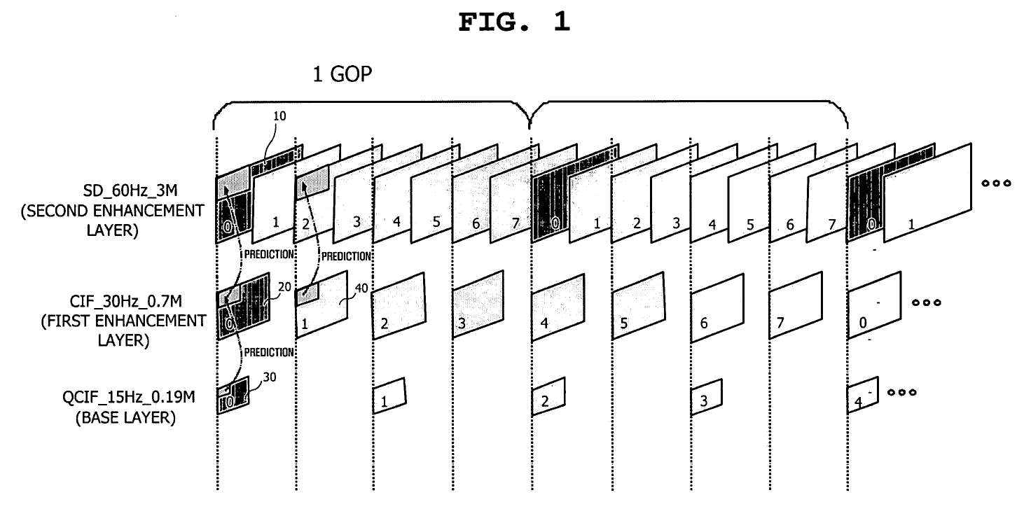

### DESCRIPTION OF EXEMPLARY EMBODIMENTS

Hereinafter, exemplary embodiments of the present invention will be described in detail with reference to the attached drawings. The features and advantages of the present invention will be more clearly understood from the embodiments, which will be described in detail in conjunction with the accompanying drawings. However, the present invention is not limited to the disclosed embodiments, but can be implemented in various forms. The embodiments are provided to complete the disclosure of the present invention, and to sufficiently notify those skilled in the art of the scope of the present invention. The present invention is defined by the attached claims. The same reference numerals are used throughout the different drawings to designate the same or similar components.

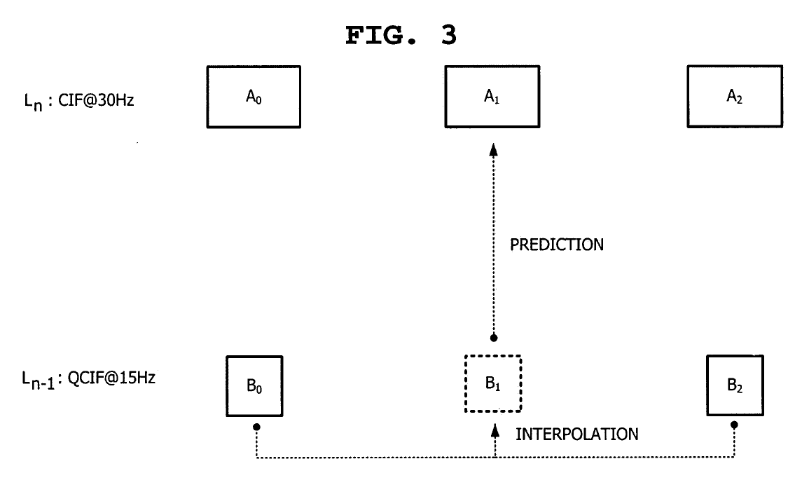

FIG. 3 is a schematic diagram showing the basic concept of Virtual Base-layer Prediction (VBP) according to aspects of the present invention. In this case, it is assumed that a current layer Lₙ has the CIF resolution and a frame rate of 30 Hz, and a lower layer Lₙ₋₁ has the QCIF resolution and a frame rate of 15 Hz. In the present specification, a current layer frame having no corresponding base layer frame is defined as an “unsynchronized frame”, and a current layer frame having a corresponding base layer frame is defined as a “synchronized frame”. Since an unsynchronized frame does not have a base layer frame, the present invention proposes a method of generating a virtual base layer frame and utilizing the virtual base layer frame for Intra-BL prediction.

As shown in FIG. 3, when the frame rates of a current layer and a lower layer are different, a lower layer frame corresponding to an unsynchronized frame A₁ does not exist, so that a virtual base layer frame B₁ can be interpolated using two lower layer frames B₀ and B₂, which are closest to the unsynchronized frame A₁. Further, the unsynchronized frame A₁ can be efficiently predicted using the interpolated virtual base layer frame B₁. In the present specification, a method of predicting an unsynchronized frame using a virtual base layer frame is defined as virtual base-layer prediction (hereinafter referred to as “VBP”).

As described above, the concept of VBP according to the present invention can be applied to two layers having different frame rates. Therefore, VBP can also be applied to the case in which a current layer and a lower layer use a hierarchical inter-prediction method, such as Motion Compensated Temporal Filtering (MCTF), as well as the case in which a current layer and a lower layer use a non-hierarchical inter-prediction method (I-B-P coding of an MPEG system codec). Therefore, when a current layer uses MCTF, the concept of the VBP can be applied to the temporal level of the MCTF having a frame rate higher than that of a lower layer.

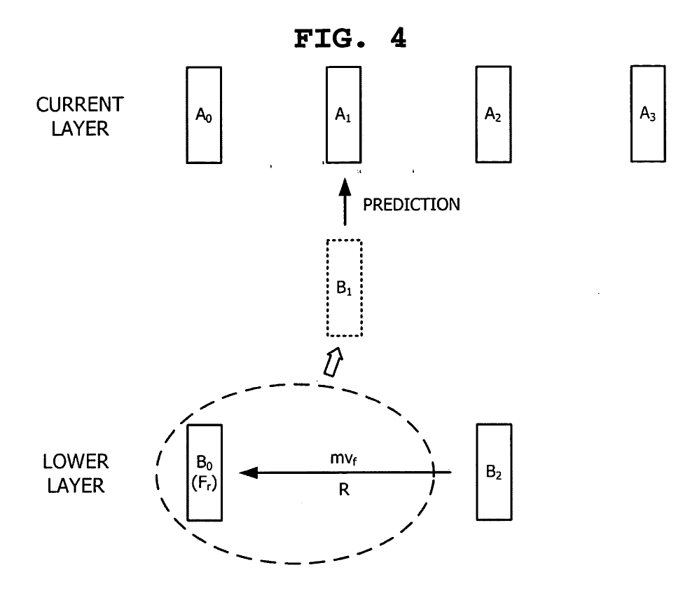

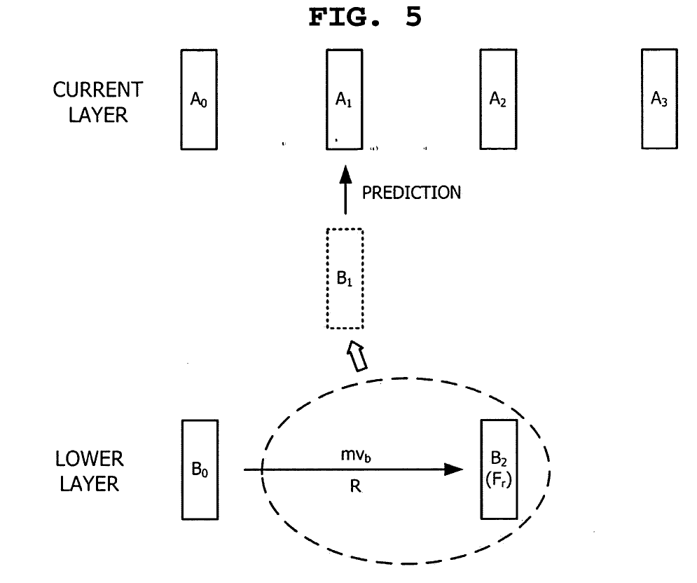

FIGS. 4 and 5 are diagrams showing examples of a method of implementing VBP according to aspects of the present invention. In the examples, a base layer frame B₁ may be generated using a motion vector, which may be generated by using one of two frames B₀ and B₂ closest to an unsynchronized frame A₁ in a lower layer as a reference frame, a residual image and the reference frame.

FIG. 4 illustrates an example of implementing VBP using the forward inter-prediction of a lower layer. Referring to FIG. 4, the frame B₂ of a base layer may be predicted through forward inter-prediction by using its previous frame B₀ as a reference frame. That is, after a forward motion vector mv_{f} is obtained by using the previous frame B₀ as a reference frame Fᵣ, the reference frame may be motion-compensated using the obtained motion vector, and the frame B₂ may be inter-predicted using the motion-compensated reference frame.

In the exemplary embodiment of FIG. 4, a virtual base layer frame B₁ may be generated using the forward motion vector mv_{f}, which may be used for inter-prediction in the base layer, the frame B₀, which may be used as the reference frame Fᵣ, and a residual image R generated by subtracting B₀ from B₂.

FIG. 5 illustrates an example of implementing VBP using the backward inter-prediction of a base layer. Referring to FIG. 5, the frame B₀ of a base layer may be predicted through backward inter-prediction by using the subsequent frame B₂ as a reference frame. That is, after a backward motion vector mv_{b} is obtained by using the subsequent frame B₂ as a reference frame Fᵣ, the reference frame may be motion-compensated using the obtained motion vector, and the frame B₀ may be inter-predicted using the motion-compensated reference frame.

In the exemplary embodiment of FIG. 5, a virtual base layer frame B₁ may be generated using the backward motion vector mv_{b}, which may be used for inter-prediction in the base layer, the frame B₂, which may be used as the reference frame Fᵣ, and a residual image R generated by subtracting B₂ from B₀.

In the present specification, by way of additional description for clarification, an inter-prediction method referring to a temporally previous frame is designated forward prediction, and an inter-prediction method referring to a temporally subsequent frame is designated backward prediction.

Hereinafter, a method of generating a virtual base layer frame according to aspects of the present invention may include two processes. The method may include a first process of considering only variation in motion and generating a temporary frame, and a second process of applying variation in texture to the temporary frame and generating a virtual base layer frame.

Consideration of Variation in Motion

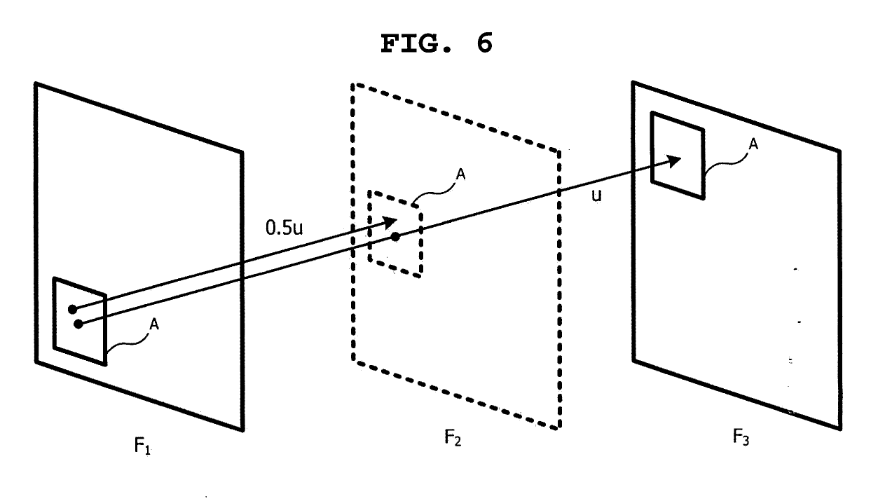

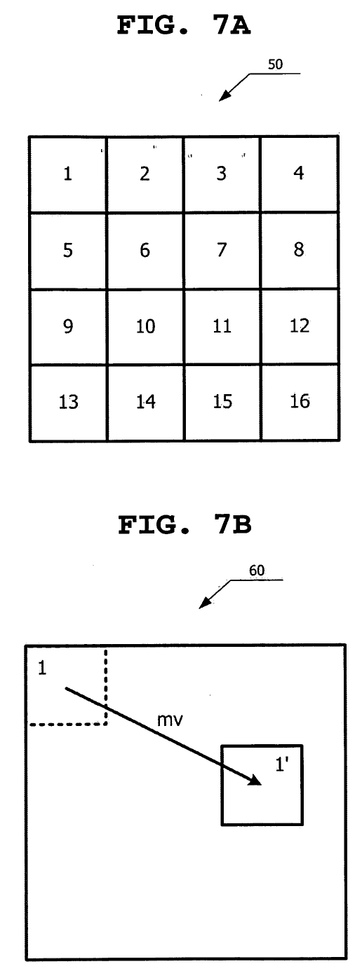

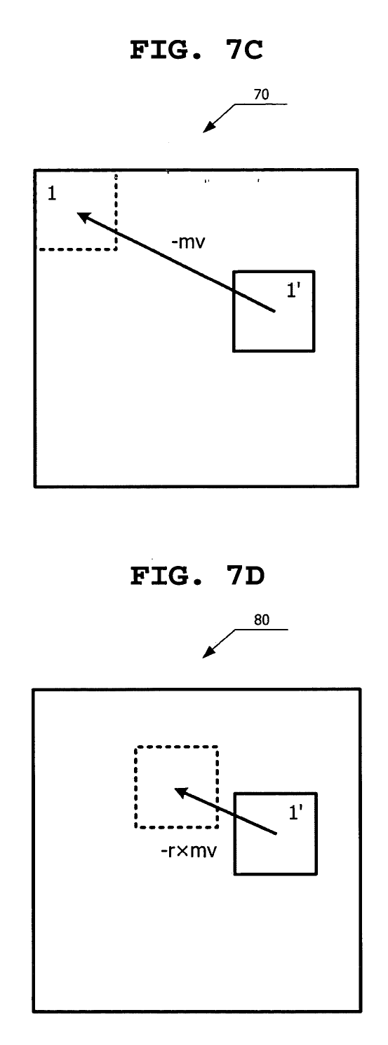

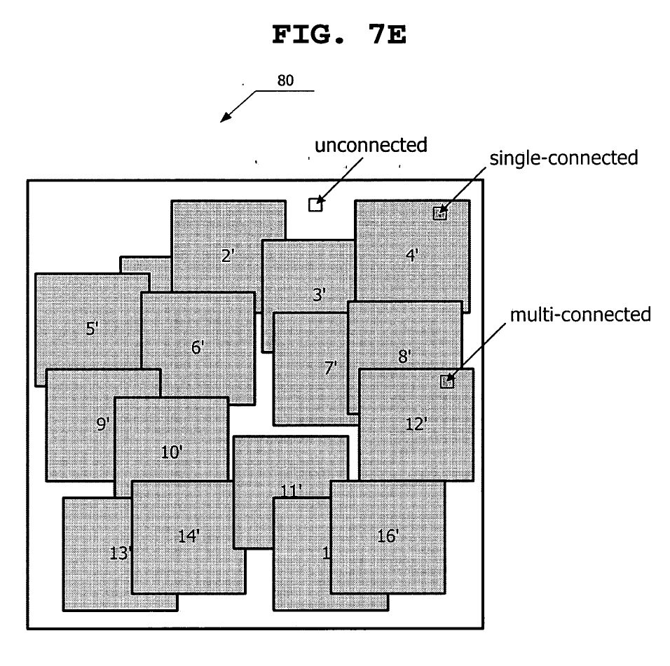

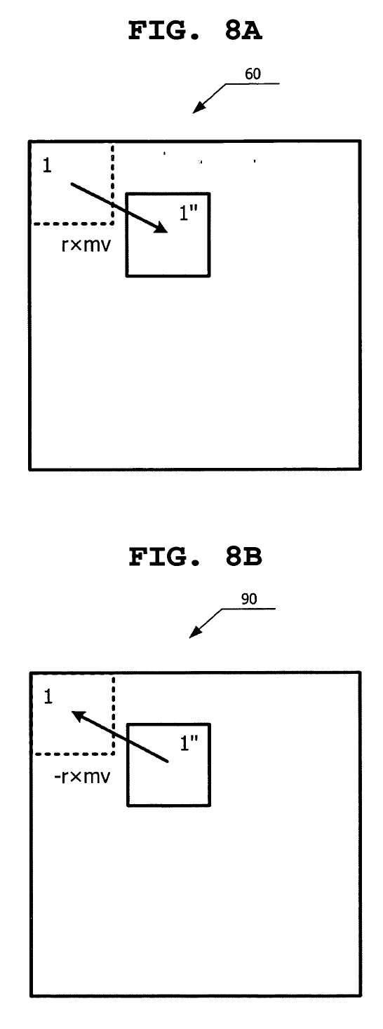

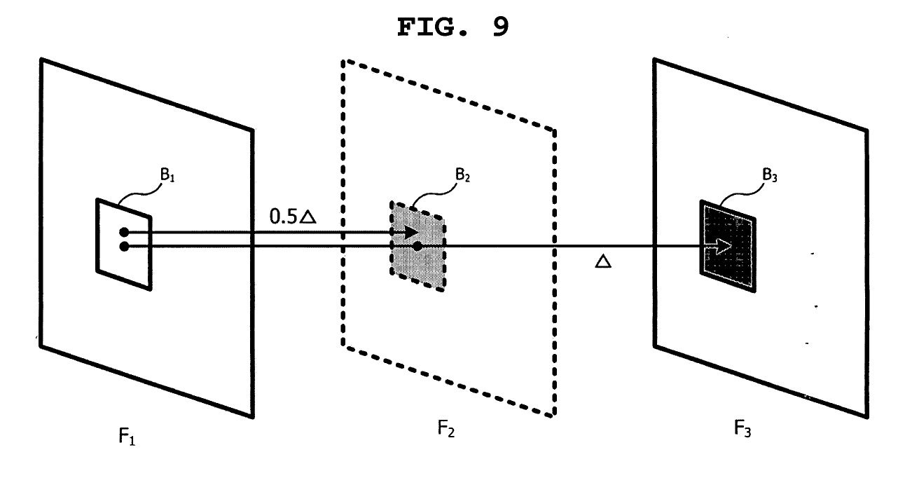

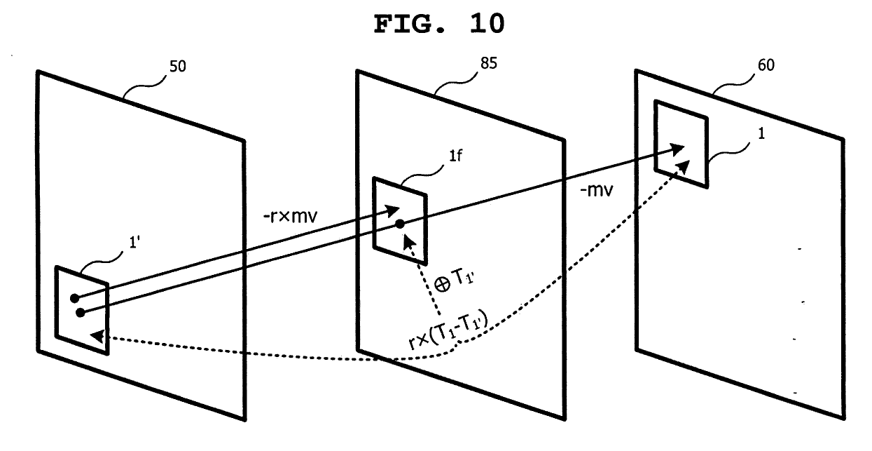

In the exemplary embodiments of the present invention, a concept of a process of considering variation in motion and generating a temporary frame, as shown in FIG. 6, will be described. If there are temporally adjacent frames F₁ and F₃, and a certain object A moves upwards from a lower position as time elapses in the frames F₁ and F₃, the location of the object A in a virtual frame F₂ that is disposed between the frames F₁ and F₃ can be predicted to be at the center 0.5u of a path u along which the object A moves between the frames F₁ and F₃. As described above, a temporary (virtual) frame, generated in consideration of variation in motion between the two frames of the base layer, is based on the above-described concept. Hereinafter, FIG. 7A to FIG. 8B are diagrams showing methods of obtaining the temporary frame.

FIGS. 7A to 7E are diagrams showing the concept of the generation of a temporary frame according to a first exemplary embodiment of the present invention. First, it is assumed that, of two base layer frames closest to an unsynchronized frame, one frame 50 to be inter-predicted (hereinafter referred to as an “inter-frame”) is composed of a plurality of partitions, as shown in FIG. 7A. In the case of forward prediction, the frame 50 may be B₂ of FIG. 4, while, in the case of backward prediction, the frame 50 may be B₀ of FIG. 5. In the present specification, each “partition” means a unit area used for motion estimation, that is, for searching for a motion vector. The partition may have a fixed size (for example, 4×4, 8×8, or 16×16), as shown in FIG. 7A, or it may have a variable size as in the case of the H.264 codec.

The existing H.264 utilizes Hierarchical Variable Size Block Matching (HVSBM) technology to perform inter-prediction on each macroblock (16×16 size) constituting a single frame. The macroblock can be divided into sub-blocks in a 16×16 mode, 8×16 mode, 16×8 mode, or 8×8 mode. Each of the sub-blocks having an 8×8 size can be further divided into sub-blocks in a 4×8 mode, 8×4 mode or 4×4 mode (if it is not divided, the 8×8 mode is used without change). If the above-described HVSBM technology is used, a single frame is implemented with a set of macroblocks each having the above-described various combinations of partitions, each partition having a single motion vector.

As described above, a “partition” in the present invention means a unit of area to which a motion vector is assigned. It should be apparent that the size and shape of a partition can vary according to the type of codec. However, for explanatory convenience, the inter-frame 50 is assumed to have fixed-size partitions, as shown in FIG. 7A. Further, in the present specification, reference numeral 50 denotes the inter-frame of a lower layer (for example, B₂ of FIG. 4, and B₀ of FIG. 5), and reference numeral 60 denotes a reference frame (for example, B₀ of FIG. 4 and B₂ of FIG. 5) used for inter-prediction of the inter-frame.

If the motion vector mv of a partition 1 in the frame 50 is determined as shown in FIG. 7B, an area in the reference frame 60 corresponding to the partition 1 is an area 1′ at a location that is moved away from the location of the partition 1 by the motion vector. In this case, a motion compensated frame 70 for the reference frame may be generated by duplicating texture data of the area 1′ in the reference frame 60 to the location of the partition 1, as shown in FIG. 7C. When this process is executed with respect to the remaining partitions 2 to 16 in the same manner and all areas are filled with texture data, the motion compensated frame 70 is completed.

In the first exemplary embodiment of the present invention, a temporary frame 80 may be generated in consideration of the principles of generating the motion compensated frame, as shown in FIG. 7D. That is, since a motion vector represents a direction in which a certain object moves in a frame, motion compensation may be performed to an extent corresponding to a value obtained by multiplying the motion vector by the ratio of the distance between the reference frame 60 and the location at which the temporary frame 80 is to be generated, to the distance between the reference frame 60 and the inter frame 50 (hereinafter referred to as a “distance ratio”, which is 0.5 in FIGS. 4 and 5). In other words, the temporary frame 80 may be filled with texture data in such a way that the area 1′ may be duplicated to a location moving away from the area 1′ by −r×mv, where r is the distance ratio and mv is the motion vector. When this process is executed with respect to the remaining partitions 2 to 16 in the same manner, and all areas are filled with texture data, the temporary frame 80 is completed.

The first exemplary embodiment is based on a basic assumption that a motion vector represents the movement of a certain object in a frame, and the movement may be generally continuous in a short time unit, such as a frame interval. However, the temporary frame 80 generated according to the method of the first embodiment may include, for example, an unconnected pixel area and a multi-connected pixel area, as shown in FIG. 7E. In FIG. 7E, since a single-connected pixel area includes only one piece of texture data, there is no problem. However, a method of processing pixel areas other than the single-connected pixel area may be an issue.

As an example, a multi-connected pixel may be replaced with a value obtained by averaging a plurality of pieces of texture data at corresponding locations connected thereto. Further, an unconnected pixel may be replaced with a corresponding pixel value in the inter-frame 50, with a corresponding pixel value in the reference frame 60, or with a value obtained by averaging corresponding pixel values in the frames 50 and 60.

It is difficult to expect high performance when an unconnected pixel area or a multi-connected pixel area is used for Intra-BL prediction for an unsynchronized frame, compared to the single-connected pixel area. However, there is a high probability that inter-prediction or directional intra-prediction for an unsynchronized frame, rather than Intra-BL prediction, will be selected as a prediction method for the above areas from the standpoint of costs, and the performance deterioration is unlikely to occur. Further, in the single-connected pixel area, Intra-BL prediction will exhibit sufficiently high performance. Accordingly, if the pixel areas are determined to be a single frame unit, the enhancement of performance can be expected when the first exemplary embodiment is applied.

FIGS. 8A and 8B are diagrams showing the concept of the generation of a virtual base layer frame according to a second exemplary embodiment of the present invention. The second exemplary embodiment is proposed to improve the problem whereby an unconnected pixel area and a multi-connected pixel area exist in the temporary frame 80 generated in the first exemplary embodiment. The pattern of partitions of a temporary frame 90 in the second exemplary embodiment uses the pattern of partitions of the inter-frame 50 without change.

Also in the second exemplary embodiment, description is made with the assumption that the inter-frame 50 is as shown in FIG. 7A and a motion vector for a specific partition 1 is as shown in FIG. 7B. In the second exemplary embodiment, as shown in FIG. 8A, an area in a reference frame 60 corresponding to the partition 1 is an area 1″ at a location that is moved away from the location of the partition 1 by r×mv. In this case, the temporary frame 90 may be generated in such a way that texture data of the area 1″ in the reference frame 60 may be copied to the same location as the partition 1, as shown in FIG. 8B. When this process is executed with respect to the remaining partitions 2 to 16 in the same manner and all areas are filled with texture data, the temporary frame 90 is completed. Since the temporary frame 90 generated in this way has the same partition pattern as the inter-frame 50, the temporary frame 90 includes only single-connected pixel areas without including unconnected pixel areas or multi-connected pixel areas.

The first and second exemplary embodiments can be independently implemented, but one embodiment, into which the embodiments are combined, can also be considered. That is, the unconnected pixel area of the temporary frame 80 in the first exemplary embodiment may be replaced with the corresponding area of the temporary frame 90 obtained in the second exemplary embodiment. Further, the unconnected pixel area and the multi-connected pixel area of the temporary frame 80 in the first exemplary embodiment may be replaced with the corresponding areas of the temporary frame 90 obtained in the second exemplary embodiment.

Consideration of Variation in Texture

In the above description, a process of considering variation in motion and generating the temporary frame 80 or 90 has been described. However, variation in texture itself, as well as variation in motion, also naturally exists between adjacent frames. For example, if it is assumed that a motion vector is 0 with respect to adjacent frames F₁ and F₃, as shown in FIG. 9, a certain object B can be considered to be disposed at the same location in the frames F₁ and F₃. However, an image B₁ of the object B in the frame F₁ is not identical to an image B₃ of the object B in the frame F₃. For example, when lighting becomes dim or bright, the texture of the same object may vary considerably as its temporal location varies.

Therefore, 1/2 of the texture variation Δ(0.5Δ) between the two frames F₁ and F₃ is applied to an image B₂ of the object B in a frame F₂ interpolated at the center of the distance between the two frames F₁ and F₃. That is, B₂ can be simply expressed by: B₁+0.5Δ.

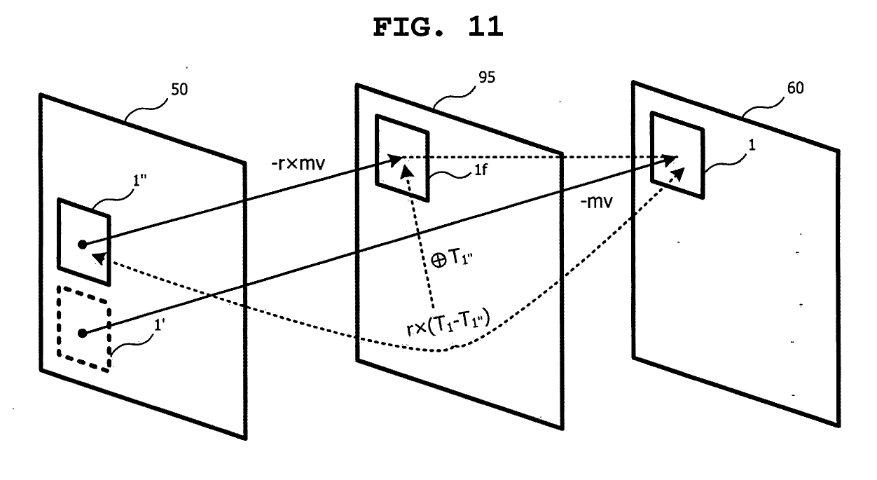

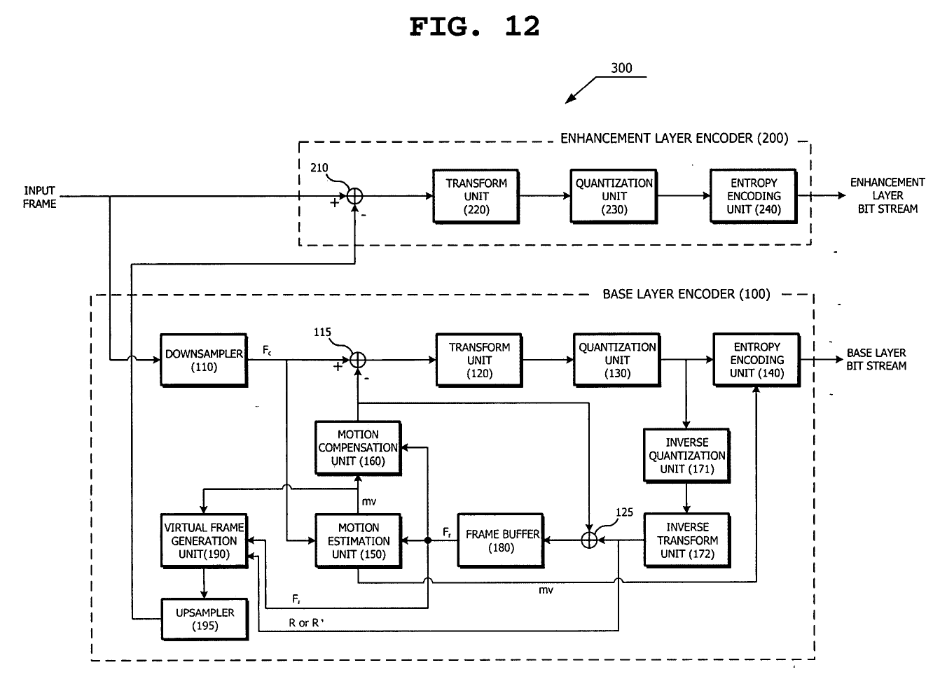

FIGS. 10 and 11 are diagrams showing a process of applying variation in texture to a temporary frame, generated in consideration of variation in motion, and generating a virtual base layer frame. FIG. 10 is a diagram showing a process of considering variation in texture in the first exemplary embodiment.

As shown in FIG. 7D, the partition 1′ in the reference frame 60 corresponding to the certain partition 1 in the inter frame 50 may be copied to a location away from the partition 1′ by −r×mv in the temporary frame 80. At this time, a value obtained by applying a distance ratio to the difference between the texture T₁ of the partition 1 and the texture T₁ of the corresponding partition 1′, that is, r×(T₁−T_{1′}), is a texture variation in the virtual base layer frame on the basis of the reference frame.

Therefore, the texture T_{1f} of a final partition 1f constituting the virtual base layer frame may be obtained by adding r×(T₁−T_{1′}) to the texture T₁ of the partition 1′ copied to the temporary frame 80. Of course, since the location of the partition If is the same as that of the partition 1′ copied to the temporary frame 80, the partition If may be generated by replacing the partition 1′, copied to the temporary frame 80, with T_{1′}+r×(T₁−T_{1′}); if r=0.5, the equation becomes: T_{1f}=(T₁−T_{1′})/2.

However, if a closed loop encoding technique is used to maintain symmetry between a video encoder and a video decoder, the texture of a reconstructed image, not the texture of an original frame, may be used. Accordingly, the texture T_{1f} of the final partition 1f may be expressed by Equation [1], where Rec( . . . ) denotes a reconstructed texture image obtained by decoding an encoded texture after a certain texture has been encoded.
T_{1f}=Rec(T_{1′})+r×Rec(T₁−Rec(T_{1 ′})) [1]

However, T₁−Rec(T_{1′}) of Equation [1] is the result obtained by subtracting a reconstructed texture in a reference frame, corresponding to a certain partition in the inter-frame 50, from the certain partition in the inter frame 50, and it denotes a residual image generated by performing inter-prediction on the frame 60. Further, Rec(T₁−Rec(T_{1′})) denotes a resultant image obtained by reconstructing the residual image. Therefore, in the first exemplary embodiment there is no need to execute a separate process for calculating Rec(T₁−Rec(T_{1′})), so reconstruction results for the inter-prediction may be used without change.

When the above process is repeatedly executed with respect to the remaining partitions 2 to 16, the temporary frame 80 may be replaced with a virtual base layer frame 85 according to the first exemplary embodiment. That is, the virtual base layer frame 85 may be generated.

FIG. 11 is a diagram showing a process of considering variation in texture in the second exemplary embodiment.

As described above with reference to FIG. 8B, the partition 1″ in the reference frame 60 corresponding to a certain partition 1 may be copied to the same location in the temporary frame 90 as that of the partition 1. In this case, a value obtained by applying a distance ratio to the difference between the texture T₁ of the partition 1 and the texture T_{1″}of the corresponding partition 1″, that is, r×(T₁−T_{1″})), is a texture variation in the virtual base layer frame on the basis of the reference frame.

Therefore, the texture T_{1f} of a final partition 1f constituting the virtual base layer frame may be obtained by adding r×(T₁−T_{1″}) to the texture T_{1″} of the partition 1″ copied to the temporary frame 90. Of course, since the location of the partition If is the same as that of the partition 1″ copied to the temporary frame 90, the partition If may be generated by replacing the partition 1″ with T_{1″}+r×(T₁−T_{1″}).

However, if a closed loop encoding technique is used to maintain symmetry between a video encoder and a video decoder, the texture of a reconstructed image, not the texture of an original frame, may be used. Accordingly, the texture T_{1f} of the final partition 1f may be expressed by the following Equation [2].
T_{1f}=Rec(T_{1′})+r×Rec(T₁−Rec(T_{1 ″})) [2]

However, in Equation [2], T₁−Rec(T_{1″}) differs from a residual image used for inter-prediction, unlike the first exemplary embodiment. That is, in inter-prediction, the texture T₁ at a location spaced apart from the location of the partition 1′ by a motion vector may be used, but in Equation [2], the texture T_{1″} at a location spaced apart from the location of the partition 1′ by r×mv, may be used. Therefore, a separate process for calculating Rec(T₁−Rec(T_{1″})) is required.

When the above process is repeatedly executed with respect to the remaining partitions 2 to 16, the temporary frame 90 may be replaced with a virtual base layer frame 95 according to the second exemplary embodiment. That is, the virtual base layer frame 95 may be generated.

In the previous description, a method of generating a temporary frame during a process of considering motion information, and finally generating a virtual base layer frame during a process of considering texture information, has been described. However, in reality, regardless of the processes, a virtual base layer may be generated by copying the texture T_{1f} of a partition, calculated using Equation [1] or [2], to the corresponding location of the virtual base layer frame.

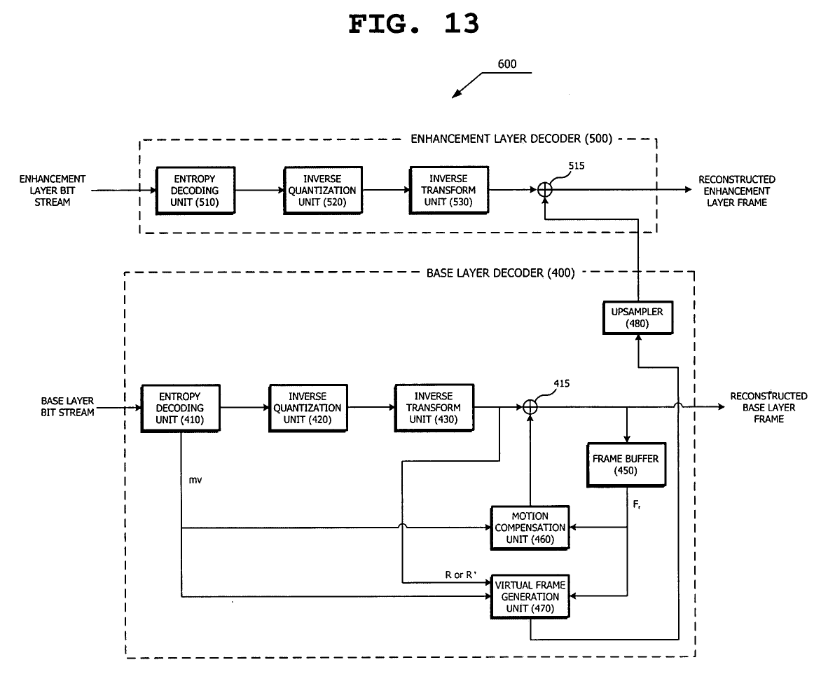

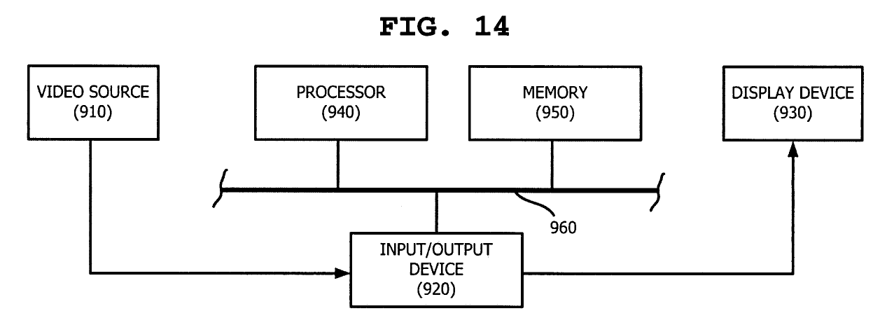

FIG. 12 is a block diagram showing the construction of a video encoder 300 according to an exemplary embodiment of the present invention. In FIG. 12 and FIG. 13, an example in which a single base layer and a single enhancement layer are used is described, but those skilled in the art will appreciate that the present invention can be applied to a lower layer and a current layer even though the number of layers used increases.

The video encoder 300 may be divided into an enhancement layer encoder 200 and a base layer encoder 100. First, the construction of the base layer encoder 100 is described.

A downsampler 110 may downsample input video to a resolution and a frame rate appropriate for a base layer. From the standpoint of resolution, downsampling may be performed using an MPEG downsampler or wavelet downsampler. Further, from the standpoint of frame rate, downsampling may be easily performed using a frame skip method, a frame interpolation method, and others.

A motion estimation unit 150 may perform motion estimation on a base layer frame, and obtain a motion vector mv with respect to each partition constituting the base layer frame. Such motion estimation denotes a procedure of finding an area most similar to each partition of a current frame F_{c} in a reference frame Fᵣ, that is, an area having a minimum error, and may be performed using various methods, such as a fixed size block matching method or a hierarchical variable size block matching method. The reference frame Fᵣ may be provided by a frame buffer 180. The base layer encoder 100 of FIG. 12 may adopt a scheme in which a reconstructed frame is used as a reference frame, that is, a closed loop encoding scheme. However, the encoding scheme is not limited to the closed loop encoding method; the base layer encoder 100 may adopt an open loop encoding scheme in which an original base layer frame, provided by the downsampler 110, may be used as a reference frame.

A motion compensation unit 160 may perform motion compensation on the reference frame using the obtained motion vector. Further, a subtractor 115 may obtain the difference between the current frame F_{c} of the base layer and the motion compensated reference frame, thus generating a residual frame.

A transform unit 120 may perform a spatial transform on the generated residual frame and generate a transform coefficient. For the spatial transform method, a Discrete Cosine Transform (DCT), or a wavelet transform may be used. When a DCT is used, the transform coefficient denotes a DCT coefficient, and when a wavelet transform is used, the transform coefficient denotes a wavelet coefficient.

A quantization unit 130 may quantize the transform coefficient generated by the transform unit 120. Quantization refers to an operation of dividing the DCT coefficient, expressed as an arbitrary real number, into predetermined intervals based on a quantization table, representing the intervals as discrete values, and matching the discrete values to corresponding indices. A quantization result value obtained in this way is designated a quantized coefficient.

An entropy encoding unit 140 may perform non-lossy encoding on the quantized coefficient generated by the quantization unit 130, and the motion vector generated by the motion estimation unit 150, thus generating a base layer bit stream. For the non-lossy encoding method, various non-lossy encoding methods, such as Huffman coding, arithmetic coding or variable length coding may be used.

Meanwhile, an inverse quantization unit 171 may perform inverse quantization on the quantized coefficient output from the quantization unit 130. Such an inverse quantization process is the inverse of the quantization process, and is a process of reconstructing indices, which are generated during the quantization process, through the use of the quantization table used in the quantization process.

An inverse transform unit 172 may perform an inverse spatial transform on an inverse quantization result value. This inverse spatial transform is the inverse of the transform process executed by the transform unit 120. In detail, an inverse DCT, an inverse wavelet transform, and others can be used.

An adder 125 may add the output value of the motion compensation unit 160 to the output value of the inverse transform unit 172, reconstruct the current frame, and provide the reconstructed current frame to the frame buffer 180. The frame buffer 180 may temporarily store the reconstructed frame and provide the reconstructed frame as a reference frame to perform the inter-prediction on another base layer frame.

Meanwhile, a virtual frame generation unit 190 may generate a virtual base layer frame to perform Intra-BL prediction on an unsynchronized frame of an enhancement layer. That is, the virtual frame generation unit 190 may generate the virtual base layer frame using a motion vector mv obtained between the two base layer frames temporally closest to the unsynchronized frame, a reference frame Fᵣ of the two frames, and a residual frame R between the two frames.

For this operation, the virtual frame generation unit 190 may receive the motion vector mv from the motion estimation unit 150, the reference frame Fᵣ from the frame buffer 180, and the reconstructed residual frame R from the inverse transform unit 172.

The virtual frame generation unit 190 is described in relation to FIG. 10 according to a first exemplary embodiment. The virtual frame generation unit 190 may read the texture T₁ of the partition 1′ corresponding to the partition 1 of the current frame 60 from the reference frame Fᵣ. Further, the virtual frame generation unit 190 may add a texture T₁−T_{1′} to the texture T_{1′} at the location corresponding to the partition 1 in the residual frame R, and copy the addition results to a location in the virtual base layer frame away from the location of the partition 1′ by −r×mv.

The virtual frame generation unit 190 is described in relation to FIG. 11 according to a second exemplary embodiment. The virtual frame generation unit 190 may read the texture T_{1″} of the partition 1″ from the reference frame Fr at a location away from the partition 1 by r×mv. However, the residual frame according to the second exemplary embodiment differs from an existing residual frame R, as shown in FIG. 12, so that the residual frame may be generated through a separate process. However, the process itself may use the construction presented in FIG. 12 without change. That is, the motion compensation unit 160 may perform motion compensation based on a new motion vector (r×mv) obtained by multiplying r by the motion vector mv, and not based on the motion vector mv. A subsequent process may be the same as that of FIG. 12, and therefore detailed drawings are omitted. In this case, the second exemplary embodiment may be realized by utilizing a residual frame R′, which has been reconstructed by and output from the inverse transform unit 172.

That is, after the texture T₁−T_{1″} is added to the texture T_{1′} at the location corresponding to the partition 1 in the residual frame R′, the addition results may be duplicated to the location of the partition 1′ in the virtual base layer frame.

In this way, the virtual base layer frame generated by the virtual frame generation unit 190 may be selectively provided to the enhancement layer encoder 200 through an upsampler 195. The upsampler 195 may upsample the virtual base layer frame at the resolution of the enhancement layer when the resolutions of the enhancement layer and the base layer are different. When the resolutions of the base layer and the enhancement layer are the same, the upsampling process may be omitted.

Next, the construction of the enhancement layer encoder 200 is described.

If an input frame is an unsynchronized frame, the input frame and a virtual base layer frame, provided by the base layer encoder 100, may be input to a subtractor 210. The subtractor 210 may subtract the virtual base layer frame from the input frame and generate a residual frame. The residual frame may be converted into an enhancement layer bit stream through a transform unit 220, a quantization unit 230, and an entropy encoding unit 240, and the enhancement layer bit stream may be output. The function and operation of the transform unit 220, the quantization unit 230 and the entropy encoding unit 240 are similar to those of the transform unit 120, the quantization unit 130 and the entropy encoding unit 140, respectively, and therefore detailed descriptions thereof are omitted.

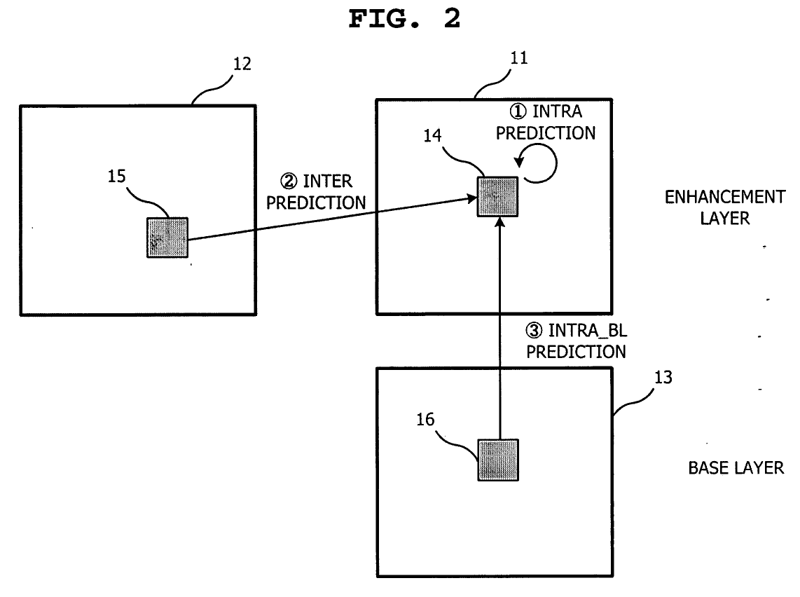

The enhancement layer encoder 200 of FIG. 12 is described with respect to the encoding of an unsynchronized frame among input frames. Those skilled in the art will appreciate that if the input frame is a synchronized frame, three conventional prediction methods may be selectively used to perform encoding, as described above with reference to FIG. 2.

FIG. 13 is a block diagram showing the construction of a video decoder 600 according to an exemplary embodiment of the present invention. The video decoder 600 may be divided into an enhancement layer decoder 500 and a base layer decoder 400. First, the construction of the base layer decoder 400 is described.

An entropy decoding unit 410 may perform non-lossy decoding on a base layer bit stream, thus extracting texture data of a base layer frame and motion data (a motion vector, partition information, a reference frame number, and others).

An inverse quantization unit 420 may perform inverse quantization on the texture data. This inverse quantization process corresponds to the inverse of the quantization process executed by the video encoder 300, and is a process of reconstructing indices, which are generated during the quantization process, through the use of the quantization table used in the quantization process.

An inverse transform unit 430 may perform an inverse spatial transform on the inverse quantization result value, thus reconstructing a residual frame. This inverse spatial transform is the inverse of the transform process executed by the transform unit 120 of the video encoder 300. In detail, an inverse DCT, an inverse wavelet transform, and others may be used as the inverse transform.

Meanwhile, an entropy decoding unit 410 may provide motion data, which may include a motion vector mv, both to a motion compensation unit 460 and to a virtual frame generation unit 470.

The motion compensation unit 460 may perform motion compensation on a previously reconstructed video frame provided by a frame buffer 450, that is, a reference frame, using the motion data provided by the entropy decoding unit 410, thus generating a motion compensated frame.

An adder 515 may add a residual frame reconstructed by the inverse transform unit 430 to the motion compensated frame generated by the motion compensation unit 460, thus reconstructing a base layer video frame. The reconstructed video frame may be temporarily stored in the frame buffer 450, and may be provided to the motion compensation unit 460 or the virtual frame generation unit 470 as a reference frame in order to reconstruct other subsequent frames.

The virtual frame generation unit 470 may generate a virtual base layer frame to perform Intra-BL prediction on an unsynchronized frame of an enhancement layer. That is, the virtual frame generation unit 470 may generate the virtual base layer frame using a motion vector mv obtained between the two base layer frames temporally closest to the unsynchronized frame, a reference frame Fᵣ of the two frames, and a residual frame R between the two frames. For this operation, the virtual frame generation unit 470 may receive the motion vector mv from the entropy decoding unit 410, the reference frame Fᵣ from the frame buffer 450, and the reconstructed residual frame R from the inverse transform unit 430.

A process of generating the virtual base layer frame using the motion vector, the reference frame and the residual frame is similar to that of the virtual frame generation unit 190 of the video encoder 300, and therefore detailed descriptions thereof are omitted. However, in the second embodiment, a residual frame R′ may be obtained by performing motion compensation on the reference frame of two reconstructed base layer frames using r×mv and subtracting the motion compensated reference frame from a current frame.

The virtual base layer frame generated by the virtual frame generation unit 470 may be selectively provided to the enhancement layer decoder 500 through an upsampler 480. The upsampler 480 may upsample the virtual base layer frame at the resolution of the enhancement layer when the resolutions of the enhancement layer and the base layer are different. When the resolutions of the base layer and the enhancement layer are the same, the upsampling process may be omitted.

Next, the construction of the enhancement layer decoder 500 is described. If part of an enhancement layer bit stream related to an unsynchronized frame is input to an entropy decoding unit 510, the entropy decoding unit 510 may perform non-lossy decoding on the input bit stream and extract the texture data of the unsynchronized frame.

The extracted texture data may be reconstructed as a residual frame through an inverse quantization unit 520 and an inverse transform unit 530. The function and operation of the inverse quantization unit 520 and the inverse transform unit 530 are similar to those of the inverse quantization unit 420 and the inverse transform unit 430.

An adder 515 may add the reconstructed residual frame to the virtual base layer frame provided by the base layer decoder 400, thus reconstructing the unsynchronized frame.

In the previous description, the enhancement layer decoder 500 of FIG. 13 has been described based on the decoding of an unsynchronized frame among input frames. Those skilled in the art will appreciate that if an enhancement layer bit stream is related to a synchronized frame, reconstruction methods according to three conventional prediction methods may be selectively used, as described above with reference to FIG. 2.

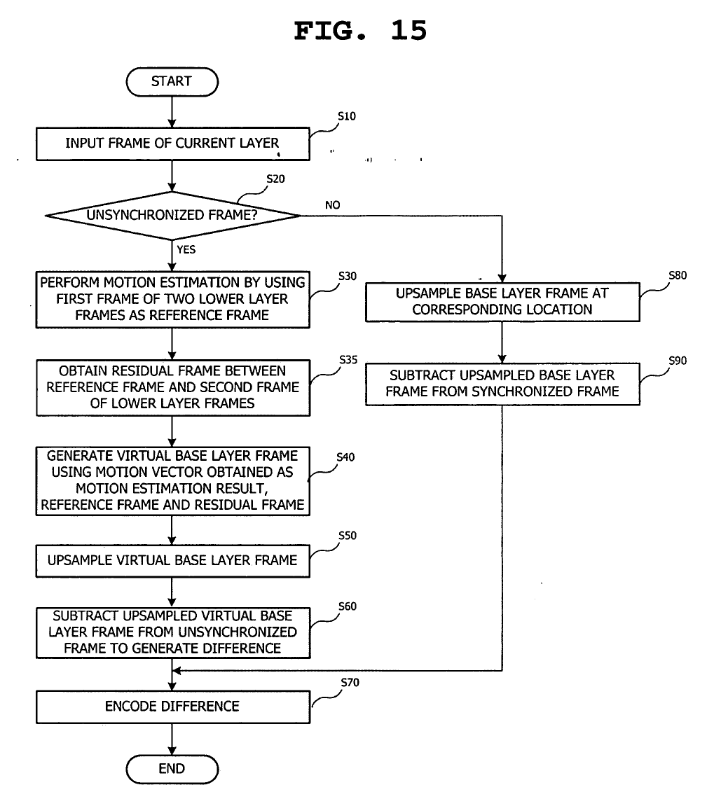

FIG. 14 is a diagram showing the construction of a system environment, in which the video encoder 300 or video decoder 600 is operated, according to an exemplary embodiment of the present invention. Such a system may be, for example, but not limited to, a TV, set-top box, desk-top computer, lap-top computer, palmtop computer, Personal Digital Assistant (PDA), video or image storage device (for example, a Video Cassette Recorder (VCR) or Digital Video Recorder (DVR) Moreover, the system may be a combination of the devices, or a specific device including another device as a part of the specific device. The system may include at least one video source 910, at least one input/output device 920, a processor 940, memory 950, and a display device 930.

The video source 910 may be, for example, but not limited to, a TV receiver, a VCR, or another video storage device. Further, the video source 910 may include a connection to one or more networks for receiving video from a server using the Internet, a Wide Area Network (WAN), a Local Area Network (LAN), a terrestrial broadcast system, a cable network, a satellite communication network, a wireless network, or a telephone network. Moreover, the video source may be a combination of the networks, or a specific network including another network as a part of the specific network.

The input/output device 920, the processor 940, and the memory 950 may communicate with each other through a communication medium 960. The communication medium 960 may be a communication bus, a communication network, or one or more internal connection circuits. The input video data received from the source 910 may be processed by the processor 940 using one or more software programs stored in the memory 950, or it may be executed by the processor 940 to generate output video to be output to the display device 930.

In particular, the software program stored in the memory 950 may include a multi-layered video codec for performing the method of the present invention. The codec may be stored in the memory 950, be read from a storage medium, such as Compact Disc-Read Only Memory (CD-ROM) or a floppy disc, or be downloaded from a server through various networks. The codec may be replaced with a hardware circuit implementing the software, or with a combination of software and hardware circuits.

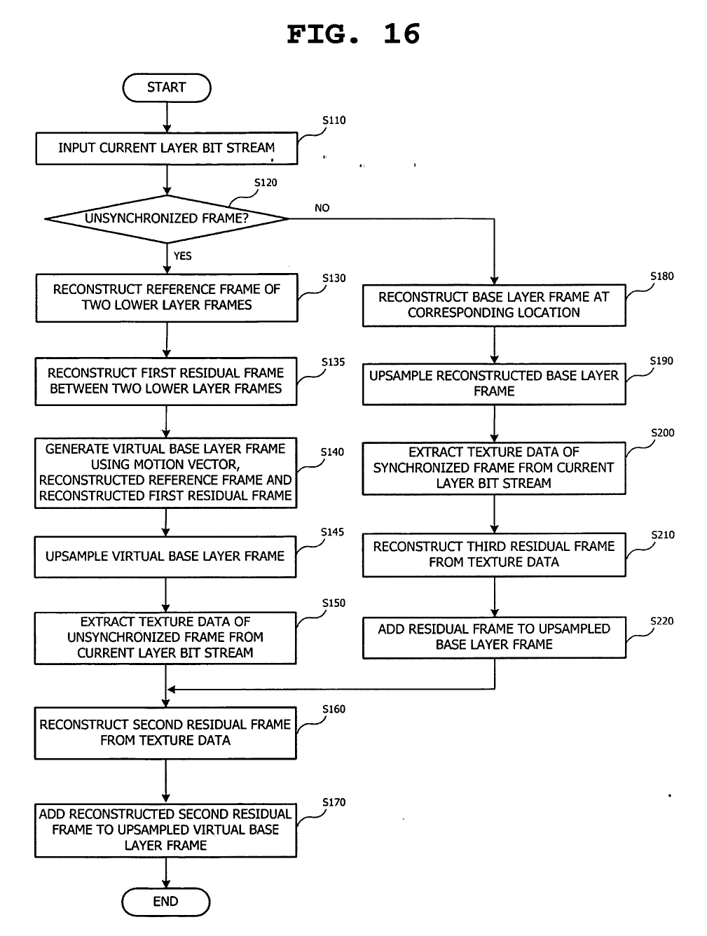

FIG. 15 is a flowchart showing a video encoding process according to an exemplary embodiment of the present invention.

Referring to FIG. 15, if the frame of a current layer is input to the enhancement layer encoder 200 in S10, whether the frame is an unsynchronized frame or a synchronized frame may be determined in S20.

As a result of the determination, if the frame is an unsynchronized frame (“yes” in S20), the motion estimation unit 150 may perform motion estimation by using a first frame (of two lower layer frames) that is temporally closest to the unsynchronized frame of the current layer as a reference frame in S30. The motion estimation may be performed in fixed size blocks or hierarchical variable size blocks. The reference frame may be a temporally previous frame of the two lower layer frames as shown in FIG. 4, or a temporally subsequent frame as shown in FIG. 5.

A residual frame between the reference frame and a second frame of the lower layer frames is obtained in S35. According to a first exemplary embodiment of the present invention, S35 may include encoding the first frame using the subtractor 115, the transform unit 120 and the quantization unit 130, and then decoding the encoded first frame using the inverse quantization unit 171, the inverse transform unit 172 and the adder 125; the motion compensation unit 160 performing motion compensation on the decoded first frame using a motion vector, the subtractor 115 subtracting the motion compensated first frame from the second frame to generate a difference; and encoding the difference using the transform unit 120 and the quantization unit 130 and then decoding the encoding results using the inverse quantization unit 171 and the inverse transform unit 172. Through this process, a residual frame R according to the first exemplary embodiment may be obtained.

According to a second exemplary embodiment of the present invention, referring again to FIG. 15, S35 may include encoding the first frame using the subtractor 115, the transform unit 120 and the quantization unit 130, and then decoding the encoded first frame using the inverse quantization unit 171, the inverse transform unit 172 and the adder 125; the motion compensation unit 160 performing motion compensation on the decoded first frame using a result vector obtained by multiplying the motion vector by a distance ratio r; the subtractor 115 subtracting the motion compensated first frame from the second frame to generate a difference; and encoding the difference using the transform unit 120 and the quantization unit 130 and then decoding the encoding results using the inverse quantization unit 171 and the inverse transform unit 172. Through this process, a residual frame R′ according to the second exemplary embodiment may be obtained.

Then, the virtual frame generation unit 190 may generate a virtual base layer frame at the same temporal location as the unsynchronized frame using the motion vector, which has been obtained as a result of motion estimation, the reference frame and the residual frame in S40.

According to a first exemplary embodiment of the present invention, S40 may include reading texture data of an area 1′ spaced apart from the location of a partition 1, to which the motion vector is assigned, from the reference frame; adding results, obtained by multiplying texture data T₁−T_{1′} corresponding to the location of the partition 1 in the residual frame R by a distance ratio r, to the read texture data T_{1′}; and copying the addition results T_{1f} to a location away from the area by a value, obtained by multiplying the motion vector by the distance ratio, in a direction opposite the motion vector.

According to a second exemplary embodiment of the present invention, S40 may include reading texture data T_{1″} of an area 1″ spaced apart from the location of the partition 1, to which the motion vector is assigned, by a value obtained by multiplying the motion vector mv by the distance ratio r, from the reference frame; adding results, obtained by multiplying the texture data T₁−T_{1″} corresponding to the location of the partition 1′ in the residual frame R′ by the distance ratio r, to the read texture data T_{1″}; and copying the addition results to the location of the partition.

When the resolutions of the current layer and the lower layer are different, the upsampler 195 may upsample the generated virtual base layer frame at the resolution of the current layer in S50.

Then, the subtractor 210 of the enhancement layer encoder 200 may subtract the upsampled virtual base layer frame from the unsynchronized frame to generate a difference in S60. Further, the transform unit 220, the quantization unit 230 and the entropy encoding unit 240 may encode the difference in S70.

Meanwhile, if the frame is a synchronized frame (“no” in S20), the upsampler 190 may upsample a base layer frame at a location corresponding to the current synchronized frame at the resolution of the current layer in S80. The subtractor 210 may subtract the upsampled base layer frame from the synchronized frame to generate a difference in S90. The difference may also be encoded through the transform unit 220, the quantization unit 230 and the entropy encoding unit 240 in S70.

FIG. 16 is a flowchart showing a video decoding process according to an exemplary embodiment of the present invention.

Referring to FIG. 16, if the bit stream of a current layer is input in S110, whether the current layer bit stream is related to an unsynchronized frame may be determined in S120.

As a result of the determination, if the current layer bit stream is related to an unsynchronized frame (“yes” in S120), the base layer decoder 400 may reconstruct a reference frame from a lower layer bit stream corresponding to the two lower layer frames that are temporally closest to the unsynchronized frame of the current layer in S130. Further, a first residual frame between the two lower layer frames may be reconstructed from the lower layer bit stream in S135.

According to a first exemplary embodiment of the present invention, S135 may include the entropy decoding unit 410 extracting the texture data of an inter-frame of the two lower layer frames from the lower layer bit stream, the inverse quantization unit 420 performing inverse quantization on the extracted texture data, and the inverse transform unit 430 performing an inverse spatial transform on the inverse quantization results. As a result, a first residual frame R according to the first exemplary embodiment may be reconstructed.

According to a second exemplary embodiment of the present invention, S135 may include the entropy decoding unit 410 extracting the texture data of an inter-frame of the two lower layer frames from the lower layer bit stream, the inverse quantization unit 420 performing inverse quantization on the extracted texture data, and the inverse transform unit 430 performing an inverse spatial transform on the inverse quantization results, the motion compensation unit 460 performing motion compensation on the reconstructed reference frame using the motion vector, the adder 415 adding the inverse spatial transform results to the motion compensated reference frame, thus reconstructing an inter frame, the motion compensation unit 460 performing motion compensation on the reconstructed reference frame using a result vector obtained by multiplying the motion vector by a distance ratio, and the subtractor (not shown in FIG. 13) subtracting the motion compensated reference frame from the reconstructed inter-frame. As a result, a first residual frame R′ according to the second exemplary embodiment may be reconstructed.

Then, the virtual frame generation unit 470 may generate a virtual base layer frame at the same temporal location as the unsynchronized frame using the motion vector included in the lower layer bit stream, the reconstructed reference frame and the first residual frame in S140. The first and second embodiments may be applied to S140, similar to the video encoding process. This operation is described above with reference to S40 of FIG. 15, and therefore a detailed description thereof is omitted.

When the resolutions of the current layer and the lower layer are different, the upsampler 480 may upsample the generated virtual base layer frame at the resolution of the current layer in S145.

Meanwhile, the entropy decoding unit 510 of the enhancement layer decoder 500 may extract the texture data of the unsynchronized frame from a current layer bit stream in S150. The inverse quantization unit 520 and the inverse transform unit 530 may reconstruct a second residual frame from the texture data in S160. Then, the adder 515 may add the second residual frame to the virtual base layer frame in S170. As a result, the unsynchronized frame may be reconstructed.

If the frame is related to a synchronized frame in S120 ( “no” in S120), the base layer decoder 400 may reconstruct a base layer frame at a location corresponding to the synchronized frame in S180. The upsampler 480 may upsample the reconstructed base layer frame in S190. Meanwhile, the entropy decoding unit 510 may extract the texture data of the synchronized frame from the current layer bit stream in S200. The inverse quantization unit 520 and the inverse transform unit 530 may reconstruct a third residual frame from the texture data in S210. Then, the adder 515 may add the third residual frame to the upsampled base layer frame in S220. As a result, the synchronized frame may be reconstructed.

According to exemplary embodiments of the present invention, there is an advantage in that Intra-BL prediction can be performed with respect to an unsynchronized frame using a virtual base layer frame. Further, according to exemplary embodiments of the present invention, there is an advantage in that video compression efficiency can be improved by using a more efficient prediction method.

Although the exemplary embodiments of the present invention have been disclosed for illustrative purposes, those skilled in the art will appreciate that the present invention can be implemented in other detailed forms without changing the technical spirit or essential features of the invention. Therefore, it should be understood that the above embodiments are only exemplary in all aspects and are not restrictive.

What is claimed is:

1. A multi-layered video encoding method comprising:
a) performing motion estimation by using a first frame of two frames of a lower layer temporally closest to an unsynchronized frame of a current layer as a reference frame;
b) obtaining a residual frame between the reference frame and a second frame of the lower layer frames;
c) generating a virtual base layer frame at the same temporal location as that of the unsynchronized frame using a motion vector obtained as a result of the motion estimation, the reference frame, and the residual frame;
d) subtracting the generated virtual base layer frame from the unsynchronized frame to generate a first difference; and
e) encoding the first difference.

2. The multi-layered video encoding method according to claim 1, further comprising:
upsampling the virtual base layer frame generated in (c) at a resolution of the current layer when resolutions of the current layer and the lower layer are different,
wherein the virtual base layer frame in (d) is the upsampled virtual base layer frame.

3. The multi-layered video encoding method according to claim 1, wherein the reference frame is a temporally previous frame of the lower layer frames.

4. The multi-layered video encoding method according to claim 1, wherein the reference frame is a temporally subsequent frame of the lower layer frames.

5. The multi-layered video encoding method according to claim 1, wherein (b) further comprises:
encoding the first frame and then decoding the encoded first frame;
performing motion compensation on the decoded first frame using a motion vector;
subtracting the motion compensated first frame from the second frame to obtain a second difference; and
encoding the second difference, and then decoding the encoded second difference,
wherein the reference frame is the decoded first frame and the residual frame is the decoded second difference.

6. The multi-layered video encoding method according to claim 5, wherein (c) comprises:
reading texture data of the reference frame from an area spaced apart by the motion vector from a location of a partition, to which the motion vector is assigned;
adding results, obtained by multiplying texture data corresponding to the location of the partition in the residual frame by a distance ratio, to the read texture data; and
copying the addition results to a location that is away from the area, in a direction opposite the motion vector, by a value obtained by multiplying the motion vector by the distance ratio.

7. The multi-layered video encoding method according to claim 1, wherein (b) comprises:
encoding the first frame and then decoding the encoded first frame;
performing motion compensation on the decoded first frame using a result vector obtained by multiplying the motion vector by a distance ratio;
subtracting the motion compensated first frame from the second frame to obtain a third difference; and
encoding the third difference, and decoding the encoded third difference, thus reconstructing the residual frame,
wherein the reference frame is the decoded first frame and the residual frame is the decoded third difference.

8. The multi-layered video encoding method according to claim 7, wherein (c) comprises:
reading texture data of the reference frame from an area spaced apart from a location of a partition, to which the motion vector is assigned, by a value obtained by multiplying the motion vector by a distance ratio;
adding results, obtained by multiplying texture data corresponding to the location of the partition in the residual frame by a distance ratio, to the read texture data; and
copying the addition results to the location of the partition.

9. The multi-layered video encoding method according to claim 1, wherein (d) comprises:
performing a spatial transform on the difference, thus generating a transform coefficient;
quantizing the generated transform coefficient, thus generating a quantized coefficient; and
performing non-lossy encoding on the generated quantized coefficient.

10. A multi-layered video decoding method comprising:
a) reconstructing a reference frame from a lower layer bit stream about two frames of a lower layer temporally closest to an unsynchronized frame of a current layer;
b) reconstructing a first residual frame between the two lower layer frames from the lower layer bit stream;
c) generating a virtual base layer frame at the same temporal location as the unsynchronized frame using a motion vector included in the lower layer bit stream, the reconstructed reference frame and the first residual frame;
d) extracting texture data of the unsynchronized frame from a current layer bit stream, and reconstructing a second residual frame for the unsynchronized frame from the texture data; and
e) adding the second residual frame to the virtual base layer frame.

11. The multi-layered video decoding method according to claim 10, further comprising upsampling the virtual base layer frame generated in (c) at a resolution of the current layer when the resolution of the current layer and resolution of the lower layer are different from each other,
wherein the virtual base layer frame in (e) is the upsampled virtual base layer frame.

12. The multi-layered video decoding method according to claim 10, wherein the reference frame is a temporally previous frame of the lower layer frames.

13. The multi-layered video decoding method according to claim 10, wherein the reference frame is a temporally subsequent frame of the lower layer frames.

14. The multi-layered video decoding method according to claim 10, wherein (b) comprises:
extracting texture data of an inter-frame of the two lower layer frames from the lower layer bit stream;
performing inverse quantization on the extracted texture data; and
performing an inverse spatial transform on the inverse quantization results, thus reconstructing the first residual frame.

15. The multi-layered video decoding method according to claim 14, wherein t (c) comprises:
reading texture data of an area spaced apart from a location of a partition, to which the motion vector is assigned, by the motion vector from the reference frame;
adding results, obtained by multiplying texture data corresponding to the location of the partition in the reconstructed first residual frame by a distance ratio, to the read texture data; and
copying the addition results to a location that is away from the area in a direction opposite the motion vector by a value obtained by multiplying the motion vector by the distance ratio.

16. The multi-layered video decoding method according to claim 10, wherein (b) comprises:
extracting texture data of an inter-frame of the two lower layer frames from the lower layer bit stream;
performing inverse quantization on the extracted texture data;
performing an inverse spatial transform on the inverse quantization results;
performing motion compensation on the reconstructed reference frame using the motion vector,
adding the inverse spatial transform results to the motion compensated reference frame, thus reconstructing an inter-frame;
performing motion compensation on the reconstructed reference frame using a result vector obtained by multiplying the motion vector by a distance ratio; and
subtracting the motion compensated reference frame from the reconstructed inter-frame, thus reconstructing the first residual frame.

17. The multi-layered video decoding method according to claim 16, wherein (c) comprises:
reading texture data of the reference frame from an area spaced apart from a location of a partition, to which the motion vector is assigned, by a value obtained by multiplying the motion vector by the distance ratio;
adding results, obtained by multiplying texture data corresponding to the location of the partition in the first residual frame by a distance ratio, to the read texture data; and
copying the addition results to the location of the partition.

18. A multi-layered video encoder, comprising:
means for performing motion estimation by using a first frame of two frames of a lower layer temporally closest to an unsynchronized frame of a current layer as a reference frame;
means for obtaining a residual frame between the reference frame and a second frame of the lower layer frames;
means for generating a virtual base layer frame at the same temporal location as that of the unsynchronized frame using a motion vector obtained as a result of the motion estimation, the reference frame, and the residual frame;
means for subtracting the generated virtual base layer frame from the unsynchronized frame to generate a difference; and
means for encoding the difference.

19. A multi-layered video decoder comprising:
means for reconstructing a reference frame from a lower layer bit stream corresponding to the two frames of a lower layer temporally closest to an unsynchronized frame of a current layer;
means for reconstructing a first residual frame between the two lower layer frames from the lower layer bit stream;
means for generating a virtual base layer frame at the same temporal location as the unsynchronized frame using a motion vector included in the lower layer bit stream, the reconstructed reference frame and the first residual frame;
means for extracting texture data of the unsynchronized frame from a current layer bit stream, and reconstructing a second residual frame for the unsynchronized frame from the texture data; and
means for adding the second residual frame to the virtual base layer frame.
